(19) United States
(12) Patent Application Publication
(10) Pub. No.: US 2014/0054225 A1
(43) Pub. Date: Feb. 27, 2014

(54) METHOD AND SYSTEM FOR THE TREATMENT OF PRODUCED WATER

(71) Applicant: Carter International, LLC, Houston, TX (US)

(72) Inventors: Marcos De la Monja Carter, Guadalajara, JA (MX); Sadot Bermejo Lajud, Guadalajara (MX)

(73) Assignee: Carter International, LLC, Houston, TX (US)

(21) Appl. No.: 14/006,696

(22) PCT Filed: Oct. 9, 2012
(86) PCT No.: PCT/US12/59301

§ 371 Date: Sep. 23, 2013

(30) Foreign Application Priority Data
Oct. 11, 2011 (MX) MX/A/2011/010713

(51) Int. Cl. C02F 9/00

(52) U.S. Cl. CPC C02F 9/00
USPC 210/639

(57) ABSTRACT

This invention relates to a produced water treatment system composed of 10 stages which are:
I) Fine Screening
II) Homogenization, equalization and flow regulation
III) PH adjustment
IV) Electrofloculation and/or electrocoagulation and/or broad impact ionization
V) Primary repumping
VI) Clarification
VII) Sludge Treatment
VIII) Advanced Oxidation
IX) Filtration System
X) Reverse Osmosis

Achieving with this quality process in the final water discharge the official standard norm and any other required norm. The objective of this invention is to contribute to the improvement of the ecosystem, with a more economical process without the need of an ultrafiltration system, obtaining better results in the treatment of produced water.

### CROSS REFERENCE TO RELATED APPLICATIONS

This application is a National Stage application under 35 USC 371 of International application Serial No. PCT/US12/059301 filed Oct. 9, 2012 for “Produced Water Treatment Process”, which claims the benefit of priority to Mexican patent application Serial No. MX/A/2011/010713 filed Oct. 11, 2011. Each of these applications are incorporated by reference herein.

### BACKGROUND OF THE INVENTION

Produced water is a term used in the oil industry to describe water that is produced along with the oil and gas. Oil and gas reservoirs have a natural water layer (formation water) that lies under the hydrocarbons. These waters contain concentration of salt in range of 4 to 150 g/l (2.2 to 50 lb/barrel), addition of bicarbonates, sulfates, calcium, magnesium, organic matter.

This water can be used in the injection wells, replacing the fresh water required for the secondary recovery of the reservoirs. To achieve this reuse, the produced water needs to treated properly, that's where we are given the task of creating a process to improve the environmental conditions in Mexico and the rest of the world, offering a treatment system with high efficiency, sustainable and above all, with a low cost of operation and maintenance. There are many other treatment processes for the produced waters, but most cannot deliver a final water that complies with discharge regulations and the ones that could meet them have a high investment and high operating cost.

Nowadays there are some forms of treatment such as evaporation, electrofloculation, electrocoagulation, flotation, etc., however all of them are used in an isolated manner thus obtaining final discharge water that can hardly meet with any Country's norms concerning water treatment.

Electrofloculation and electrocoagulation are two techniques that involve the electrical addition of coagulant metal ions sent directly from the sacrificial electrode. These ions allow the contaminants to agglomerate the same way as if a chemical product would. Such chemical products can be aluminum sulfate, ferric chloride, etc.

Chemical coagulation has been used for decades in order to destabilize colloidal suspensions. Combined with chemical flocculation, the precipitation of metallic species and other inorganic species can be achieved, eliminated, later, by sedimentation and/or filtration. The coagulants used are iron salts, aluminum, lime, polymers, and others. Chemical coagulation-flocculation generates substantial volumes of strongly bound-water sludge, which often delays the difficult filtration and drying of sludge. It also increases the salinity of the water, which may make it unacceptable for reuse.

Dissolved air flotation (DAF) is another process of solid-liquid separation widely used in industrial water clarification, for example in the sugar industry, mining, oil industry, and in many wastewater treatment systems. The DAF process is used to separate suspensions and emulsions of molecular weights close to that of the water, which makes their separation by sedimentation or filtration extremely difficult.

### DESCRIPTION OF THE INVENTION

This process has been designed using high impact ionization technology and/or electrofloculation and/or electrocoagulation, dissolved air flotation system (DAF), ozone, reverse osmosis and filtration with an active carbon and zeolite filtration agent.

With this process we seek to:
a) Remove the solids greater than 1 mm before entering the processing train.
b) Impact and control the potential “Z” influent water.
c) Removing associated carbonates and salts prior to reverse osmosis.
d) Reduce total dissolved solids (TDS) in the primary treatment and thereby reduce investment and operating costs.
e) Eliminate primary ultrafiltration costs.
f) Eliminate fats and oils as well as hydrocarbons in general prior to the osmosis process.
g) Reduce the total suspended solids (TSS) to values of <10 mg/l of water from the primary treatment, eliminating the ultrafiltration stage.
h) Deliver a final water discharge with high removal percentages of contaminants including turbidity<10 NTU.
i) Deliver final process water under Mexican Standard Norm NOM-143-SEMARNAT-2003.

This technology's development allows us to condition the water for treatment, to dissociate the molecules of dissolved solids such as salts, carbonates and metals for subsequent removal from the water without the use of ultrafiltration. Another benefit of this approach is that it can work with a continuous flow 24 hours a day, 365 days a year without any operational problem.

In the drawing we can observe that the process submitted for patent is comprised of 10 stages.

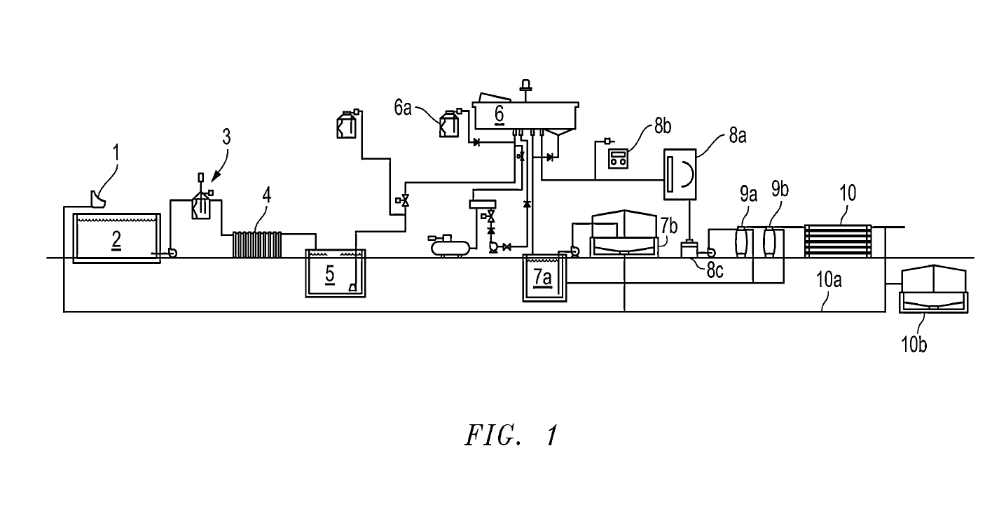

I) STAGE ONE: FINE SCREENING; here the wastewater can reach either by gravity or by pumping to a fine screen of settleable solids 1 mm of mesh filter made of stainless steel type 304 (1 FIG. 1), capable of removing solids up to 1 mm thick, this will prevent the solids greater than 1 mm from entering a process train. The capacity of the hydroscreen will depend on the flow to be treated and the amount of solids in the water. At this stage we will adjust the process flow.

II) STAGE TWO: HOMOGENIZATION, FLOW EQUALIZATION AND REGULATION; the water will flow by gravity from the screen of fine settleable solids to homogenizer, equalization and regulation flow tank where concentrations, volumes, pH, will be equalized along with water resistance time in order to have better control of potential “Z”. The hydraulic retention time of this tank is 3 hours (2 FIG. 1). The homogenizer tank material is irrelevant to our process as it can be a gap with geomembranes, reinforced plastic, reinforced concrete or steel type. The tank may have a mechanism of mechanical agitation, or by air, without affecting the treatment process, as is required to maintain a homogeneous mixture. Then 2 pumps will be installed to power the train pre-treatment process with the design flow, the pumps will be scheduled to work alternately, ie one works while the other is at rest. The outflow from this tank sensors will be installed that will monitor the total suspended solids, total dissolved solids and pH in order to know the values to remove and make the necessary adjustments. It is necessary to provide flow measurements of various points of injection into the tank homogenizer.

III) STAGE THREE: PH ADJUSTMENT; will be held in a container made of plastic, stainless steel or epoxy coated concrete with a storage capacity that allows you to have a hydraulic retention time from 4 to 6 minutes. This container will have a mixed system mechanical type or aeration (3 FIG. 1), the PH of water will be adjusted in a range between 6 and 8. An acid or alkaline solution will be used for this adjustment which will be contained in a plastic or steel tank of any kind equipped with dosing pumps.

IV) STAGE FOUR: SYSTEM OF HIGH-IMPACT IONIZATION AND/OR ELECTROFLOCULATIONS AND/OR ELECTROCOAGULATION: the flow of water coming from the pH adjustment tank (3 FIG. 1) will reach another reinforced plastic container by gravity or pumping (4 FIG. 1). The retention time in this step may vary between 4 minutes to 2 hours according to physicochemical characteristic of the produced water to treat, this system is done through anode and cathode electrodes which may be for sacrifice or not energized by a AC power or direct current source which is defined according to the physico-chemical characteristics of the produced water to be treated. The treated water in the system of high impact ionization and/or electrofloculation and/or electrocoagulation is discharged by gravity to a re-pumping tank (5 FIG. 1).

V) STAGE FIVE: PRIMARY REPUMPING: re-pumping tank receives the flow from stage four with a storage capacity to achieve hydraulic retention time of up to 30 minutes. The tank may have a mechanism of mechanical agitation, or by air, without this affecting the treatment process, as is required to maintain a homogeneous mixture (5 FIG. 1).

VI) STAGE SIX: CLARIFICATION: The water will reach the system by pumping. The clarification is performed by a system of advanced dissolved air flotation where suspended solids are removed without the use of ultrafiltration, eliminating backwash and changes of filter media (6 FIG. 1). The clarification is performed in only 3 minutes.

Fats, oils, hydrocarbons, suspended solids and colloidal particles of water are removed with an efficiency of up to 99%. To achieve efficiency of clarification is necessary the chemical conditioning of water by the addition of anionic and cationic surfactants, which are stored in plastic containers and dosing is carried out through pumps (6a FIG. 1). Suspended solids formed in the ionization molecular dissociation also be removed in this step of the process and will be disposed outside the total solids accumulated in the water in the form of floated sludge layer and sent by gravity for subsequent disposal confinement.

VII) STAGE SEVEN: SLUDGE HANDLING: The floated sludge produced during the clarification stage will be stored in a container for later transfer (7a FIG. 1) to the dehydration system which can be either drying beds, evaporation, centrifuge decanting, filter press, belt filter or any other method known for this purpose (7b FIG. 1).

VIII) STAGE EIGHT: ADVANCED OXIDATION: The clarified water in the DAF system will flow to the ozone tank or contact tower (8a FIG. 1). Ozone is obtained by means of a generator and pure oxygen concentrator (8b FIG. 1). The ozone will be injected through a fine bubble diffuser and then re-circulated. The retention time in this step depends on the results obtained from the analysis of water in particular. An ozone breaker equipment will be implemented in order to remove residual ozone venting into the atmosphere. At this point in the process a flow meter is needed in order to monitor the amount of treated water in the process. The water is deposited in a storage tank for subsequent pumping (8c FIG. 1).

IX) STAGE NINE: FILTRATION SYSTEM: The water retained in the storage tank will be pumped, to a filtration system which purpose shall be the polishing of the final processed water by removing suspended solids, nitrogen remaining, color and odor of water. The material used in the filters will be, in one step, zeolite (9a FIG. 1), and in a second step, activated carbon (9b FIG. 1). Also the removal of some soluble metals that have passed the process train, will also be eliminated. At this point of the post filtration, sensors will be installed that will monitor the total suspended solids, pH and total dissolved solids.

X) STAGE TEN: INVERSE OSMOSIS: according to the official discharge norm it will be necessary or not the inclusion of inverse osmosis; this will depend on two issues; the first, from the specific discharge area and the second from the quality of the water coming from the drilling process. Places with a high concentration of total dissolved solids (TDS) (high salinity) and are far away from the sea will need the installation of an osmosis. The need of his equipment is to reduce the high concentrations of (TDS). It's worth mentioning, that the treated water can be reused in the same drilling processes or in other permissible uses for human contact. if inverse osmosis is required, the water will pass through an ultra filtration membrane where dissolved solids or salts (10a FIG. 1) will be retained and permeate the treated water for the final discharge. The reject water coming from the inverse osmosis can return to the homogenizer tank (stage two process) to be treated again or to a dehydrated salts tank (10b FIG. 1).

We claim:

1. A method for treating water comprising:
fine screening solids from a fluid stream to remove particles greater than about 1 mm in diameter;
monitoring and equalizing total suspended solids and total dissolved solids in said fluid stream;
adjusting the acidity of said fluid stream to between pH 6 and pH 8;
treating said fluid stream using high impact ionization and/or electrofloculation and/or electrocoagulation;
removing suspended solids in said fluid stream through dissolved air flotation;
injecting said fluid stream with ozone; and
filtering said fluid stream to remove any remaining nitrogen, color and odor.

2. The method of claim 1, wherein mechanical agitation is employed in said equalizing of said total suspended solids and total dissolved solids in said fluid stream.

3. The method of claim 1, wherein anode and cathode electrodes are used for said high impact ionization.

4. The method of claim 1, wherein anionic and cationic surfactants are added concurrently with said dissolved air flotation.

5. The method of claim 1, wherein said suspended solids include fats, oils, hydrocarbons and colloidal particles of water.

6. The method of claim 1, wherein a fine bubble diffuser is used for said injecting said fluid stream with ozone.

7. The method of claim 1, wherein said filtering is performed in a two step process.

8. The method of claim 1, wherein said filtering is performed in a two step process, with a first filter comprising a zeolite filter and a second filter comprising an activated carbon filter.

9. The method of claim 1, further including, after the removal of said suspended solids, providing said suspended solids to a dehydration system for processing.

10. The method of claim 1, further including, after said filtering, treating said fluid stream with inverse osmosis.

11. A system for treating water comprising:
a hydroscreen configured to screen solids from a fluid stream to remove particles greater than about 1 mm in diameter;
a homogenizer configured to monitor and equalize total suspended solids and total dissolved solids in said fluid stream;
a first fluid reservoir configured to adjust the acidity of said fluid stream to between pH 6 and pH 8;
electrodes configured to treat said fluid stream using high impact ionization and/or electrofloculation anchor electrocoagulation;
a second fluid reservoir configured to remove suspended solids in said fluid stream through dissolved air flotation;
an ozone generator configured to inject said fluid stream with ozone; and
one or more filters configured to remove any remaining nitrogen, color and odor from said fluid stream.

12. The system of claim 11, wherein mechanical agitation is employed to equalize said total suspended solids and total dissolved solids in said fluid stream.

13. The system of claim 11, wherein said electrodes comprise and anode and a cathode.

14. The system of claim 11, wherein anionic and cationic surfactants are added concurrently with said dissolved air flotation.

15. The system of claim 11, wherein said suspended solids include fats, oils, hydrocarbons and colloidal particles of water.

16. The system of claim 11, wherein said ozone generator comprises a fine bubble diffuser.

17. The system of claim 11, wherein said one or more filters includes a first filter comprising a zeolite filter and a second filter comprising an activated carbon filter.

18. The system of claim 11, further including providing said suspended solids to a dehydration system for processing.

19. The system of claim 11, further including, after said one or more filters, treating said fluid stream with inverse osmosis.
